(19) United States
(12) Patent Application Publication
(10) Pub. No.: US 2004/0044532 A1
(43) Pub. Date: Mar. 4, 2004

(54) System and method for remote audio caption visualizations

(75) Inventor: Christopher K. Karstens, Apex, NC (US)

Correspondence Address: Gerald R. Woods, IBM Corporation T81/503, P.O. Box 12195, Research Triangle Park, NC, 27709, US

(73) Assignee: International Business Machines Corporation, Armonk, NY

(21) Appl. No.: 10/233,973

(22) Filed: Sep. 3, 2002

(51) Int. Cl. G10L 21/06

(52) U.S. Cl. 704/271

(57) ABSTRACT

A system and method for remote audio caption visualizations is presented. A user uses a personal device during an event to display an enhanced captioning stream corresponding to the event. A media-playing device provides a media stream corresponding to the enhanced captioning stream. The media-playing device provides a synchronization signal to the personal device which instructs the personal device to start playing the enhanced captioning stream on the personal device's display. The user views text on the personal display while the media stream plays. The user is able to adjust the timing of the enhanced captioning stream in order to fine-tune the synchronization between the enhanced captioning stream and the media stream.

### BACKGROUND OF THE INVENTION

1. Technical Field

The present invention relates in general to a system and method for remote audio caption visualization. More particularly, the present invention relates to a system and method for playing an enhanced captioning stream on a personal device while playing a media stream on a media-playing device wherein the enhanced captioning stream is external to the media stream.

2. Description of the Related Art

Many individuals use captioning to comprehend audio or video media. Hearing impaired individuals depend on captioning for everyday activities, such as watching television shows. Individuals with normal hearing may also use captioning to comprehend a television program in public areas with high noise levels, such as in an exercise facility. Two types of captioning transmission methods are open captioning and closed captioning. Open captioning places text on a screen at all times, often in a black reader box. Closed captioning does not automatically place the text on a screen but rather uses a decoder unit to decode the captioning and place the text on the screen at a user's discretion.

A content provider (i.e. television network) may use online captioning or offline captioning to generate a captioning text stream. Online captioning is generated as an event occurs. For example, television news shows, live seminars, and sports events may use online captioning. Online captions may be generated from a script (live display), or generated in real-time. Someone listening to an event with the script loaded on a computer system generates live display captioning. The person presses a “next caption” button to show a viewer the next line of captioning. Alternatively, the script may come from a prompter in which the viewer sees the same text that the speaker is seeing. Live display typically scrolls text up one line at a time on a television screen.

A challenge of live-display is that the content provider only captions what is scripted, and if the speaker deviates from the script, the captions are incorrect. For example, a newscast using live-display may have clean, high-quality captions as an anchorperson reads the stories off of a prompter. As soon as the newscast performs a live interview, the captions stop. Typically, content providers that use prompter-based captions leave a third to a half of each newscast uncaptioned.

On the other hand, real-time captioning uses stenocaptioners to caption an entire broadcast. Stenocaptioners listen to a live broadcast and type what they hear on a shorthand keyboard. Special computer software translates the stenocaptioner's phonetic shorthand into English. A closed-caption encoder receives the phonetic shorthand and places it on the broadcast signal for a viewer to see. Stenocaptioning costs more than live-display captioning, but it allows the entire broadcast to be captioned. However, stenocaptioning is more prone to errors than live-display captioning.

Many newscasts use a combination of captioning techniques to try to achieve both the accuracy of live-display captioning and the complete coverage of real-time stenocaptioning. To accomplish this, the stenocaptioner dials in to the newsroom computer system about an hour before the broadcast, and copies all of the scripts into the captioning system. The captioner then sorts and cleans up the scripts, names the segments, and marks which ones will require live stenocaptioning.

During the broadcast, the stenocaptioner may move many times between sending script lines and writing real-time. A casual viewer may notice a difference in that real-time captions appear one word at a time wherein live display captions appear one line at a time.

Alternatively, offline captioning is performed “after the fact” in a studio. Examples of offline captioning include television game shows, videotapes of movies, and corporate videotapes (e.g., training videos). The text of the captions is created on a computer, and synchronized to the video using time codes. The captions are then transferred to the videotape before it is broadcast or distributed.

A challenge found with captioning is that limited funds and resources limit the amount of audio and video media that a content provider captions. Typically, mainstream television shows are captioned, while other less popular shows are not. While the FCC is requiring captioning for audio and video media, exceptions do apply. For example, a video programmer is not required to spend more than 2% of its annual gross revenues on captioning. Additionally, programs aired between 2:00 am and 6:00 am are not required to be captioned. Furthermore, programming from “new networks” is not required to be captioned.

Another challenge found with captioning is that movies in a movie theater rarely have captioning capability. In many cases, a hearing impaired person waits for a movie to be available in video rental stores before the person is able to view the movie with captions.

Finally, caption information in the media stream is lost during conversion to web stream formats. A challenge found is that a hearing impaired person may not be able to understand a web cast event without first downloading a corresponding transcript and follow the transcript as the speaker talks. This process may become cumbersome to the user.

What is needed, therefore, is a way for a person to view an enhanced captioning stream on an individual basis for situations when captioning is not available for a particular event.

### SUMMARY

It has been discovered that the aforementioned challenges are resolved by using a personal device to display an enhanced captioning stream that is synchronized with a corresponding media stream. The personal device uses synchronization signals from a media-playing device to synchronize the enhanced captioning stream with the media stream. A user may use the personal device to understand events that do not have captioning.

The user attends an event that includes the media-playing device that plays the media stream. For example, the user may wish to see a movie that is played on a movie projector. The user instructs the personal device to download the enhanced captioning streams. The personal device downloads the enhanced captioning stream using a variety of methods. Using the example described above, the user may download a script corresponding to the movie using a wireless connection when the user enters the movie theater. In one embodiment, the enhanced captioning stream may include graphic information to support the text.

After the personal device downloads the enhanced captioning stream, the personal device waits for the media-playing device to provide the synchronization signal. The personal device uses the synchronization signal to synchronize the enhanced captioning stream with the media stream. Using the example described above, the personal device uses the synchronization signal to align the script with the movie displayed on a screen. The synchronization signal may be an audible signal, a wireless signal, or a manual signal. An audible signal is a signal, such as a speech pattern, that the personal device detects, and matches the detected audible signal with the enhanced captioning stream. When the personal device finds a match, the personal device displays the corresponding enhanced captioning stream relative to the location point of the detected signal. A wireless signal may be an RF signal, such as Bluetooth, in which the media-playing device transmits. The wireless signal informs processing when to display the enhanced captioning stream. A manual signal may be a queue to the user as to when to push a “start” button on the personal device. For example, the user may attend a movie and push the “start” button when a particular movie scene is displayed on the movie screen.

The media playing device may provide one or more resynchronization signals throughout the duration of the media stream. For example, the user may enter the movie theater after the movie has started and miss the first audible signal. In this example, the personal device “listens” to the movie's audio and compares it with the enhanced captioning stream. When the personal device detects a match, the personal device displays the corresponding enhanced caption text relative to the movie scene. The user is also able to adjust the timing of the enhanced captioning stream on the personal device. For example, the user may change an adjustment time by selecting soft keys on a PDA to increase the speed of the enhanced captioning stream.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a personal device synchronizing with a media-playing device to display an enhanced captioning stream corresponding to a media stream;

FIG. 2 is a flowchart showing steps taken in a personal device displaying an enhanced captioning stream and adjusting the enhanced captioning stream to correlate with a media stream;

FIG. 3 is a diagram showing a personal device receiving a synchronization signal from a media playing device and displaying an enhanced captioning stream;

FIG. 4 is a detail flowchart showing steps taken in playing an enhanced captioning stream on a personal device;

FIG. 5 is a flowchart showing steps taken in generating an enhanced captioning stream corresponding to an audio stream;

FIG. 6A is a user interface window on an enhanced captioning device showing an enhanced captioning stream corresponding to a conversation;

FIG. 6B is a user interface window on an enhanced captioning device showing an enhanced captioning stream corresponding to a musical event; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

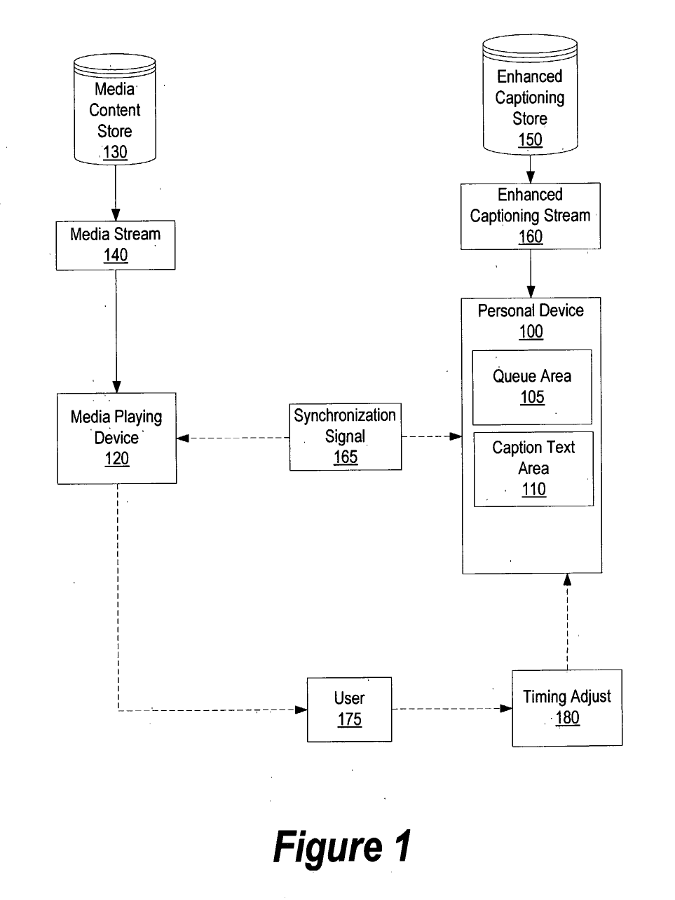

FIG. 1 is a diagram showing a personal device synchronizing with a media playing device to display an enhanced captioning stream corresponding to a media stream. User 175 may be a hearing impaired individual that uses personal device 100 to display captioned text corresponding to an event. For example, user 175 may wish to view a movie at a movie theater in which the movie does not have captioning. In another example, users may video overlay caption visualizations on their television during television shows that do not provide captioning. Personal device 100 is an electronic device that includes a display, such as a personal digital assistant (PDA), a mobile telephone, or a computer.

User 175 attends an event that includes media playing device 120. Media playing device 120 retrieves media stream 140 from media content store 130. Using the-example described above, media stream 140 may be a movie stored on digital media or the movie may be stored on a film reel. Media content store 130 may be stored on a non-volatile storage area, such as non-volatile memory. Media content store 130 may also be a storage area to store film reels.

Personal device 100 includes captioned text area 110 where processing displays enhanced caption text. In one embodiment, personal device 100 may include queue area 105 where processing displays manual synchronization queues, such as movie scenes.

Personal device 100 downloads enhanced captioning stream 160 from enhanced captioning stream store 150. Enhanced captioning stream 160 includes text and related timing information corresponding to media stream 140. In one embodiment, enhanced captioning stream 160 may include graphic information to support the text in which the graphic information may be compiled into a binary file and stored in non-volatile memory. For example, graphical information may include “bouncing ball” emoticons to display word delivery and attitude or “bouncing ball musical bar charts” may be displayed to support media streams that include music. In another embodiment, enhanced captioning stream 160 may include text in a different language than media stream 160. For example, enhanced captioning stream 160 may include text in English whereas media stream 140 may be a German movie. In yet another embodiment, personal device 100 may project perspective corrected visuals from enhanced captioning stream 160 onto a beamsplitter glass as to not disturb nearby patrons. In this example, the enhanced captioning stream is visible only to a person that is directly in front of the glass, such as with what a speaker may use on a podium while reading his speech.

In yet another embodiment, enhanced captioning stream 160 may include audio descriptions that are non-spoken words that describe what is occurring, such as an emotion of an actor (i.e. angry, sad, etc.). Personal device 100 may download enhanced captioning stream 160 using a variety of methods, such as using a global computer network (i.e. the Internet) or by using a wireless network. Using the example described above, user 175 may download a script corresponding to the movie using a wireless connection when user 175 enters the movie theater.

After personal device 100 downloads enhanced captioning stream 160, personal device 100 waits for media playing device 120 to provide synchronization signal 165. Personal device 100 uses synchronization signal 165 to synchronize the enhanced captioning stream with the media stream. Using the example described above, personal device 100 uses the synchronization signal to align the script with the movie displayed on a screen. The synchronization signal may be an audible signal, a wireless signal, or a manual signal. An audible signal is a signal, such as a speech pattern, that personal device 100 detects, and matches the detected audible signal with enhanced captioning stream 160. When processing finds a match, processing displays the enhanced captioning stream on caption text area 110 at a point corresponding to the location point of the detected signal. A wireless signal may be an RF signal, such as Bluetooth, in which media playing device 120 transmits. The wireless signal informs processing when to display the enhanced captioning stream. A manual signal may be a queue to the user as to when to push a “start” button on the personal device. For example, a user may attend a movie and push the “start” button when a particular movie scene is displayed on the movie screen.

Media playing device 120 may provide one or more re-synchronization signals throughout the duration of playing media stream 140. For example, user 175 may enter the movie theater after the movie has started and miss the first audible signal. In this example, personal device 100 “listens” to the movie's audio and compares it with enhanced captioning stream 160. When personal device 100 detects a match, personal device 100 displays enhanced caption text on caption text area 110 corresponding to the movie scene being played. In addition to personal device synchronizing on re-synchronization signals, personal device 100 may frequently re-synchronize using the media stream (i.e. audio) and matching the media stream with enhanced captioning stream 160.

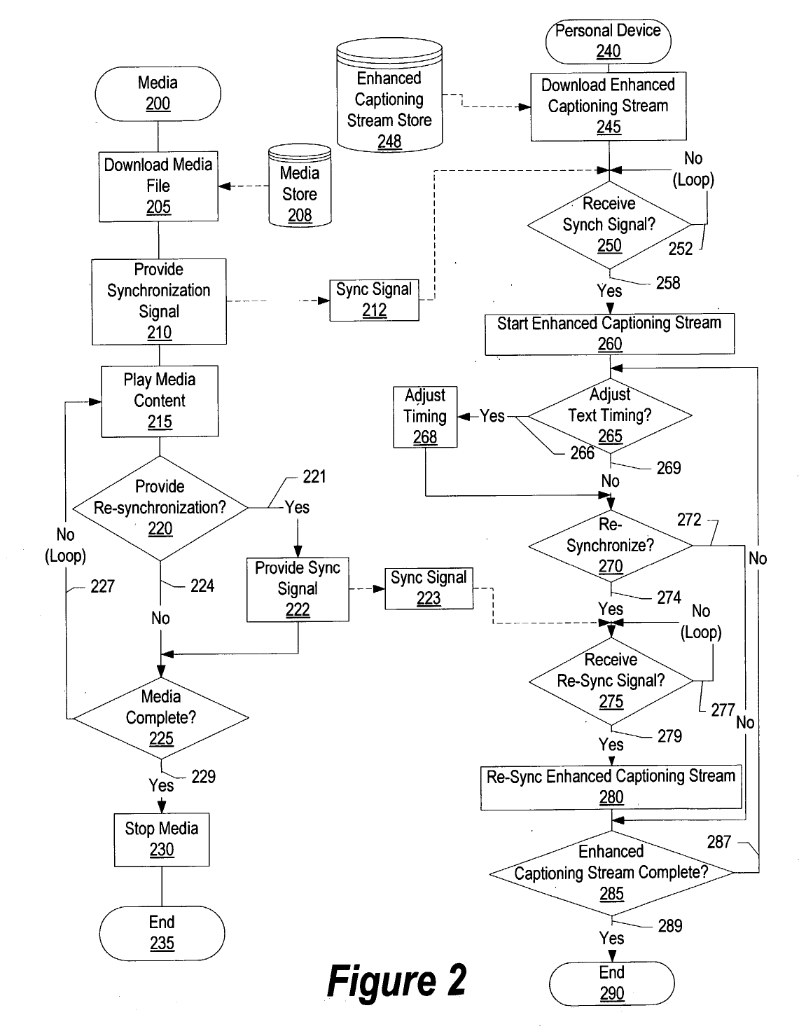

User 175 is also able to adjust the timing of the enhanced captioning stream by sending timing adjust 180 to personal device 100. For example, user 175 may change an adjustment time by selecting soft keys on a PDA to increase the speed of enhanced captioning stream 160 (see FIGS. 2 through 4 for further details regarding timing adjustment).

FIG. 2 is a flowchart showing steps taken in a personal device displaying an enhanced captioning stream and adjusting the enhanced captioning stream to correlate with a media stream. Media processing commences at 200, whereupon processing downloads a media stream file from media store 208. For example, the media stream may be a movie. Media store 208 may be stored on a non-volatile storage area, such as non-volatile memory. Media store 208 may also be a storage area to store movie film reels.

Processing provides synchronization signal 212 to the personal device which notifies the personal device to start playing the enhanced captioning stream (step 210). The synchronization signal may be an audible signal, a wireless signal, or a manual signal. An audible signal may be a speech pattern from the media stream. For example, the media-playing device may be a movie projector and the audible signal may be an actor's speech. A wireless signal may be an RF signal, such as Bluetooth, in which the media-playing device transmits to instruct the personal device to start playing the enhanced captioning stream. A manual signal may be a queue to the user as to when to push a “start” button on the personal device.

Processing plays the media stream at step 215. A determination is made as to whether to provide a re-synchronization signal to the personal device (decision 220). Using the example described above, the actor's speech may be a continuous re-synchronization signal to the personal device. Another example is a wireless signal may be sent every five minutes to inform the personal device as to what point in the movie the movie is being shown. If a re-synchronization signal should be sent to the personal device, decision 220 branches to “Yes” branch 222 which sends synchronization signal 223 to the personal device. On the other hand, if a re-synchronization signal should not be sent, decision 220 branches to “No” branch 224 bypassing re-synchronization steps.

A determination is made as to whether the media stream is finished (decision 225). If the media stream is not finished, decision 225 branches to “No” branch 227 which loops back to continue processing the media stream. This looping continues until the media stream is finished, at which point decision 225 branches to “Yes” branch 229 whereupon processing stops the media stream (step 230). Media processing commences at 235.

Personal device processing commences at 240, whereupon processing downloads an enhanced captioning stream from enhanced captioning stream store 248 (step 245). The enhanced captioning stream includes text information and timing information corresponding to a media stream. In one embodiment, the enhanced captioning stream may include graphic enhancement information corresponding to the timing information. The graphic enhancement information may be compiled into a binary file and stored in a non-volatile storage area, such as non-volatile memory. For example, processing may display a bouncing ball emoticon over each word at the word's corresponding timestamp. Processing may download the enhanced captioning stream using a global computer network, such as the Internet. In another embodiment, processing may download the enhanced captioning stream using a wireless network, such as Bluetooth. Using the example described above, a hearing impaired user may wish to view a movie at a movie theater in which the particular movie does not have captioned text. In this example, the user enters the movie theater and downloads enhanced captioning stream using a wireless network.

A determination is made as to whether the personal device receives synchronization signal 212 which informs the personal device to start playing the enhanced captioning stream (decision 250). The synchronization signal may be an audible signal, a wireless signal, or a manual signal. An audible signal is a signal, such as a speech pattern, that processing detects, and matches the detected audible signal with the enhanced captioning stream. When processing finds a match, processing displays the enhanced captioning stream at a point corresponding to the location point of the detected signal. A wireless signal may be an RF signal, such as Bluetooth, that the media-playing device transmits. The wireless signal informs processing when to display the enhanced captioning stream. A manual signal may be a queue to the user as to when to push a “start” button on the personal device. For example, a user may attend a movie and pushing the “start” button when a particular movie scene is displayed on the movie screen. If the personal device has not received a synchronization signal, decision 250 branches to “No” branch 252 which loops back to wait for the synchronization signal. This looping continues until the personal device receives synchronization signal 212, at which point decision 250 branches to “Yes” branch 258.

Processing starts playing the enhanced captioning stream at step 260. Processing uses the timing information included in the enhanced captioning stream to display words (i.e. script) on the personal device's screen in correlation with the corresponding media stream (i.e. movie) that the user is viewing. A determination is made as to whether the user wishes to adjust the timing of the displayed captioning (decision 265). Using the example described above, the user may wish to have the words displayed slightly before or after they are actually spoken. Users may also wish to display several sentences of dialogue in the past and/or future relative to when the words are spoken as a default. Another example is that the user may wish to increase the enhanced captioning stream display rate for a short time in order to “catch-up” the enhanced captioning stream to the media stream. If the user wishes to adjust the timing, decision 265 branches to “Yes” branch 266 whereupon the user changes an adjustment time (step 268). On the other hand, if the user does not wish to adjust the enhanced captioning stream timing, decision 265 branches to “No” branch 269 bypassing timing adjustment steps.

A determination is made as to whether processing wishes to re-synchronize (decision 270). Using the example described above, the user's enhanced captioning stream may be a few minutes behind the media stream and the user may wish to re-synchronize at the next scene in the movie. If the user does not wish to re-synchronize, decision 270 branches to “No” branch 272 bypassing re-synchronization steps. On the other hand, if processing wishes to resynchronize, decision 270 branches to “Yes” branch 274.

A determination is made as to whether processing has received synchronization signal 223 (decision 275). If processing has not received synchronization signal 223, decision 275 branches to “No” branch 277 to wait for synchronization signal 223. This looping continues until processing receives synchronization signal 223, at which point decision 275 branches to “Yes” branch 279 whereupon processing re-synchronizes the enhanced captioning stream (step 280).

A determination is made as to whether the enhanced captioning stream is finished (decision 285). If the enhanced captioning stream is not finished, decision 285 branches to “No” branch 287 to continue processing the enhanced captioning stream. This looping continues, until the enhanced captioning stream is finished, at which point decision 285 braches to “Yes” branch 289. Personal device processing ends at 290.

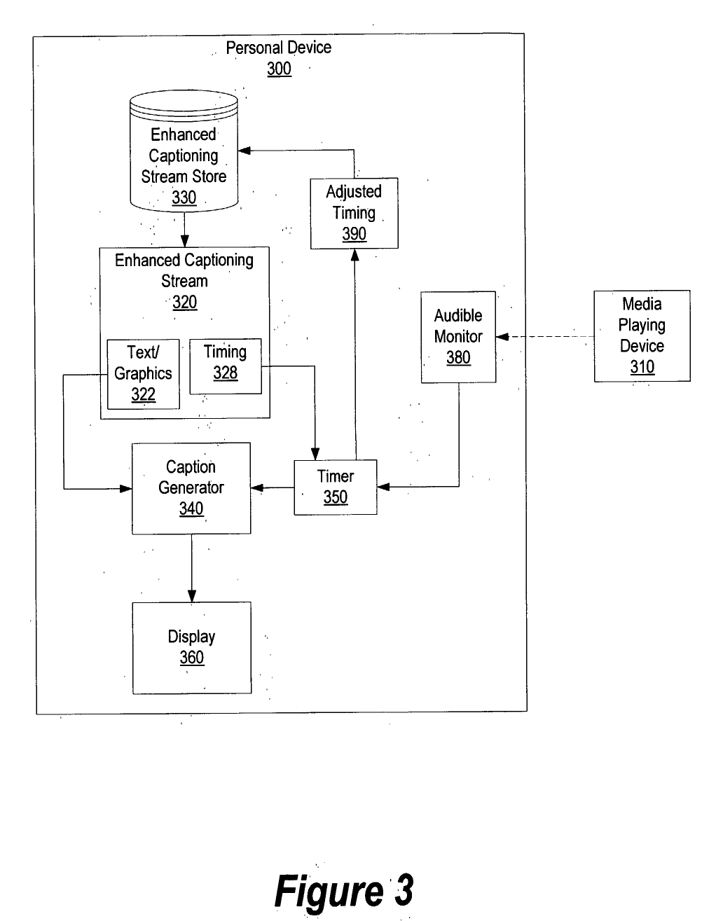

FIG. 3 is a diagram showing a personal device receiving a synchronization signal from a media playing device and displaying an enhanced captioning stream. Personal device 300 is an electronic device with a display, such as a personal digital assistant (PDA), a mobile telephone, or a computer.

Personal device 300 includes caption generator 340 which retrieves an enhanced captioning stream and displays the enhanced captioning stream on display 360. Caption generator 340 retrieves enhanced captioning stream 320 from enhanced captioning stream store 330. Enhanced captioning stream 320 includes text 322 and timing 328 which correspond to a media stream. For example, text 322 may include a movie script and timing 328 includes corresponding time-stamp information that correlates the movie script to movie scenes. Enhanced captioning stream store 330 may be stored on a non-volatile storage area, such as non-volatile memory. In one embodiment, personal device 300 may download enhanced captioning stream 320 from an external source using a global computer network or wireless network and store enhanced captioning stream 320 in its local memory (i.e. enhanced captioning stream store 330).

Personal device 300 uses audible monitor 380 to detect a synchronization signal (i.e. speech pattern) from media playing device 310. Audible monitor 380 may be a “voice engine” that is capable of detecting audio, such as speech. Audible monitor 380 matches speech patterns transmitted from media playing device 310 with locations in the enhanced captioning stream. When audible monitor 380 identifies a match, audible monitor 380 informs timer 350 at what point to display the enhanced captioning stream based upon the match location. For example, media playing device 310 may be playing a movie and audible monitor 380 is listening to the actor speaking. In this example, audible monitor searches the enhanced captioning stream for a speech pattern similar to the actor's speech.

As audible monitor 380 detects speech patterns and instructs timer 350, timer 350 may send adjusted timing 390 to enhanced captioning stream store 330. Adjusted timing 390 includes new timing information to replace timing 328 the next time enhanced captioning stream is played.

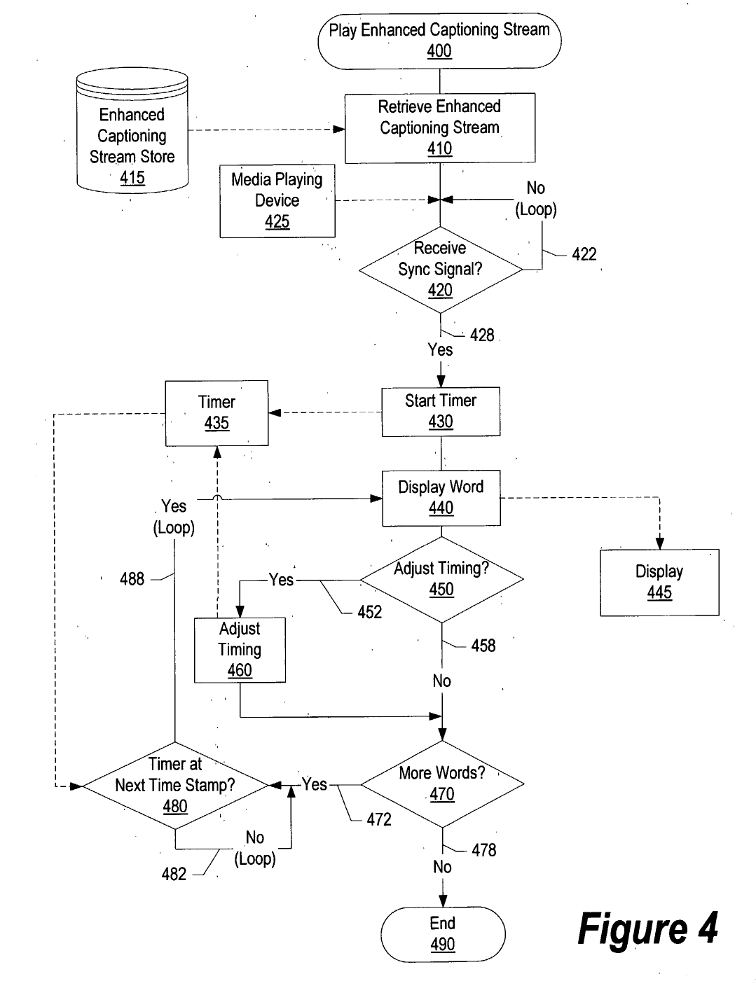

FIG. 4 is a detail flowchart showing steps taken in playing an enhanced captioning stream on a personal device. The personal device is an electronic device with a display such as a computer, a personal digital assistant (PDA), or a mobile phone. Enhanced captioning stream processing commences at 400, whereupon processing retrieves the enhanced captioning stream from enhanced captioning stream store 415 (step 410). The enhanced captioning stream includes text and timing information that correlates the text with a corresponding media stream. In one embodiment, the enhanced captioning stream may include graphic enhancement information corresponding to the timing information. The graphic enhancement information may be compiled into a binary file and stored in a non-volatile storage area, such as non-volatile memory. For example, processing may display a bouncing ball over each word at the word's corresponding timestamp. Enhanced captioning stream store 415 may be stored on a non-volatile storage area, such as non-volatile memory.

A determination is made as to whether processing receives a synchronization signal from media playing device 425 (decision 420). The synchronization signal may be an audible signal, a wireless signal, or a manual signal. An audible signal is a signal, such as a speech pattern, that processing detects, and matches the detected audible signal with the enhanced captioning stream. When processing finds a match, processing displays the enhanced captioning stream at a point corresponding to the location point of the detected signal. A wireless signal may be an RF signal, such as Bluetooth, in which media playing device 425 transmits. The wireless signal informs processing when to display the enhanced captioning stream. A manual signal may be a queue to the user as to when to push a “start” button on the personal device. For example, a user may attend a movie and push the “start” button when a particular movie scene is displayed on the movie screen.

The synchronization signal may be an automated signal or a manual signal. An automated signal example may be a movie theater sending an RF signal (i.e. Bluetooth) to the personal device which instructs the personal) device to start the enhanced captioning stream. A manual signal example may be the beginning of a movie and the user depresses a “start” button on the personal device to start the enhanced captioning stream. If processing has not received the synchronization signal, decision 420 branches to “No” branch 422 which loops back to wait for the synchronization signal. On the other hand, if processing received the synchronization signal, decision 420 branches to “Yes” branch 428.

Processing starts timer 435 which uses the timing information to instruct processing as to when to display a particular word (step 430). The first word in the enhanced captioning stream is displayed on display 445 at step 440. In one embodiment, processing may display one sentence at a time, and then highlight the first word using a different color or place a bouncing ball over the first word.

A determination is made as to whether processing should adjust the time which correlates the enhanced captioning stream text with the media stream (decision 450). For example, the media stream may be playing at a faster rate than the enhanced captioning stream and the user may wish to “speed-up” the enhanced captioning stream. If processing should adjust the timing, decision 450 branches to “Yes” branch 452 whereupon processing adjusts the timing at step 460. In one embodiment, processing may frequently detect an audible signal to synchronize the enhanced captioning stream. On the other hand, if the user does not wish to adjust the timing, decision 450 branches to “No” branch 458 bypassing timing adjustment steps.

A determination is made, as to whether there are more words to display in the enhanced captioning stream (decision 470). If there are more words in the enhanced captioning stream, decision 470 branches to “Yes” branch 472 whereupon a determination is made as to whether timer 435 has reached the next time stamp which instructs processing to display the next word (decision 480). Time stamps are included in the timing information and correspond to when each word should be displayed. If timer 435 has not reached the next time stamp, decision 480 branches to “No” branch 482 which loops back to wait for timer 435 to reach the next time stamp. This looping continues until timer 435 reaches the next time stamp, at which point decision 480 branches to “Yes” branch 488 to display the next word.

This looping continues until there are no more words to display in the enhanced captioning stream, at which point decision 470 branches to “No” branch 478. Processing ends at 490.

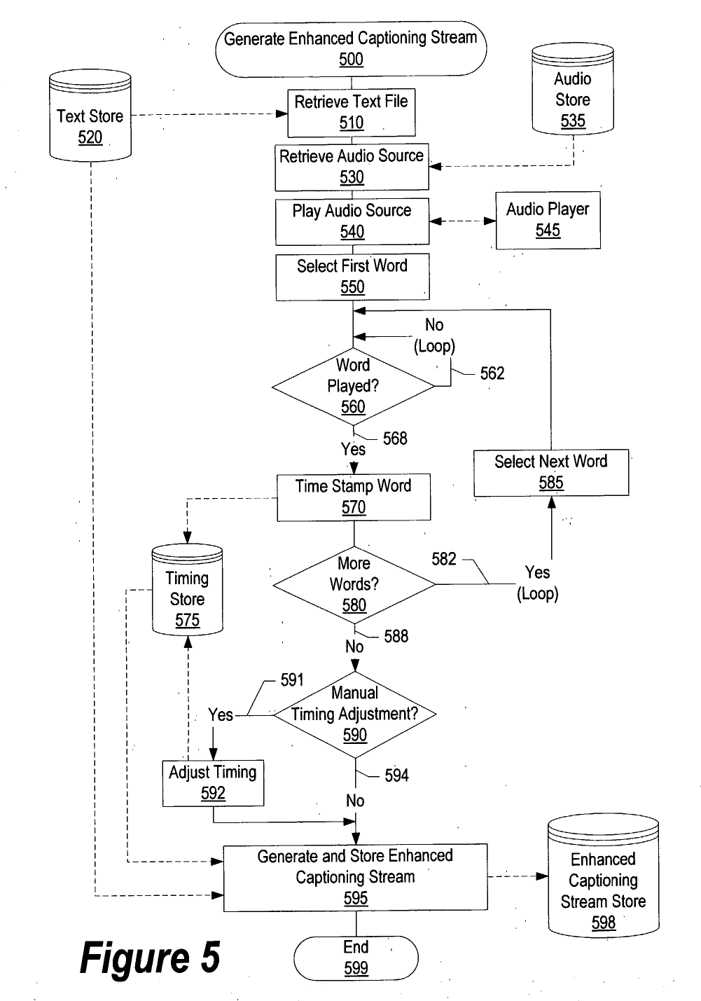

FIG. 5 is a flowchart showing steps taken in generating an enhanced captioning stream corresponding to an audio stream. Enhanced captioning stream generation commences at 500, whereupon processing retrieves a text file from text store 520 (step 510). The text file includes words corresponding to an audio stream, such as lyrics to a song or a script to a movie. Processing retrieves the corresponding audio stream from audio store 535. Processing plays the audio stream on audio player 545 at step 540. Audio player 545 may be an electronic device capable of playing an audio source or an audio/video source, such as a stereo or a television.

Processing selects the first word in the text file at step 550. A determination is made as to whether audio player 545 has played the first word in the audio file (decision 560). If the first word has not been played, decision 560 branches to “No” branch 562 which loops back to wait for audio player 545, to play the first word. This looping continues until the first word is played, at which point decision 560 branches to “Yes” branch 568 whereupon processing time-stamps the first word. For example, processing may time-stamp the first word at “t=0”.

A determination is made as to whether there are more words in the text file (decision 580). If there are more words in the text file, decision 580 branches to “Yes” branch 582 which loops back to select (step 585), and process the next word. This looping continues until there are no more words in the text file, at which point decision 580 branches to “No” branch 588.

A determination is made as to whether the user wishes to manually adjust the timing corresponding to time stamps in timing store 575 (decision 590). For example, the user may wish to increase the rate at which words are displayed on a personal device. If the user wishes to manually adjust the timing, decision 590 branches to “Yes” branch 591 whereupon the user adjusts the timing (step 592). On the other hand, if the user does not wish to manually adjust the timing, decision 590 branches to “No” branch 594 bypassing manual adjustment steps.

Processing generates an enhanced captioning stream using text information located in text store 520 and time-stamp information in timing store 575 and stores the enhanced captioning stream in enhanced captioning stream store 598 (step 595). In one embodiment, processing may add graphic enhancements corresponding to the timestamps. The graphic enhancement information may be compiled into a binary file and stored in a non-volatile storage area, such as non-volatile memory. For example, a bouncing ball may be positioned over a word when the word's corresponding timestamp comes. Processing ends at 599.

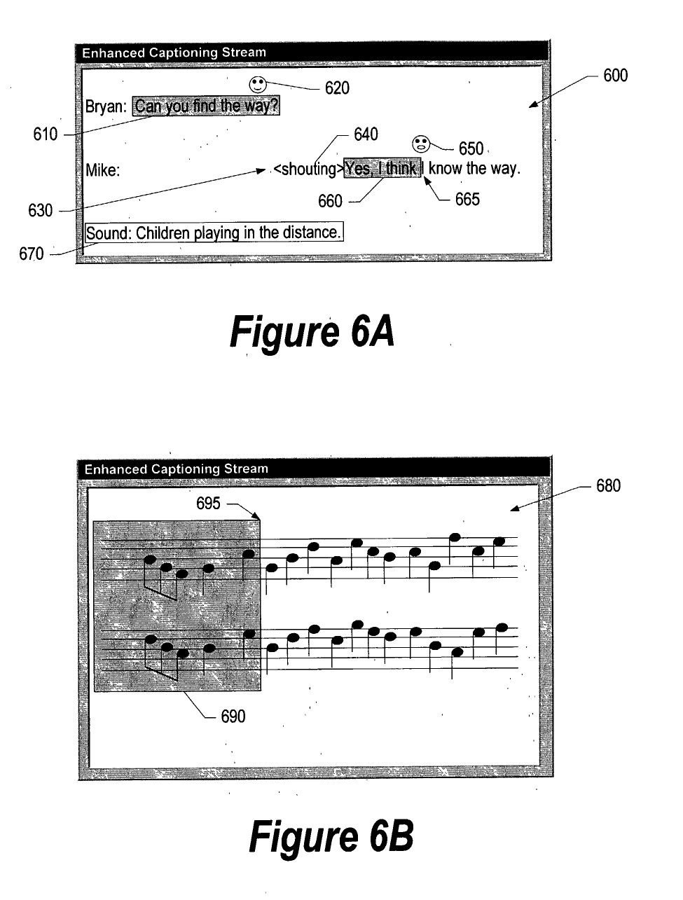

FIG. 6A is a user interface window on an enhanced captioning device showing an enhanced captioning stream corresponding to a conversation. Window 600 shows two individuals, Bryan and Mike, having a conversation. For example, Bryan and Mike may be actors in a movie in which a user is viewing. Highlight 610 shows that Bryan has already spoken his sentence. Emoticon (emotion icon) 620 shows that Bryan spoke his sentence in a pleasant tone.

Text 640 informs the user of Mike's voice tone when speaking his sentence. In this example, text 640 indicates that Mike is shouting while speaking his sentence. The speakers lines are indented to indicate the time that each speaker says his sentence as indicated at point 630. Highlight 660 indicates that Mike has spoken the first three words of his sentence, and is ready to speak the fourth word as indicated by point 665 where highlight 660 ends. Emoticon 650 shows that Mike is shouting his sentence.

Text 670 shows descriptive audio that is occurring during the conversation. In addition to descriptive audio describing sounds other than speech, descriptive audio may describe an action being performed, such as “Bryan is walking towards the fence”. Descriptive audio information may be input into devices for the visually impaired, such as a portable Braille device. Descriptive audio is stored in the enhanced captioning stream along with the time at which the enhanced captioning device should display the descriptive audio.

FIG. 6B is a user interface window on an enhanced captioning device showing an enhanced captioning stream corresponding to a musical event. Window 680 shows musical notes corresponding to a media stream, such as a song. For example, a user may be listening to a song and the enhanced captioning device is displaying notes of the song and the timing at which each note is played. Highlight 690 indicates that the first five notes of the song have been played, and the sixth note is about to be played as indicated by point 695. The, enhanced captioning device may synchronize to musical notes in the same manner in which the enhanced captioning device synchronizes to speech. The enhanced captioning device may listen to one or more notes, and compare the notes with the enhanced captioning stream. Once the enhanced captioning device detects a match between the notes and a location point within the enhanced captioning stream, the enhanced captioning device synchronizes the enhanced captioning stream with the notes, and displays, highlight 690 accordingly. The enhanced captioning device may, also receive a manual synchronization signal from the user, or a wireless synchronization signal from a media-playing device.

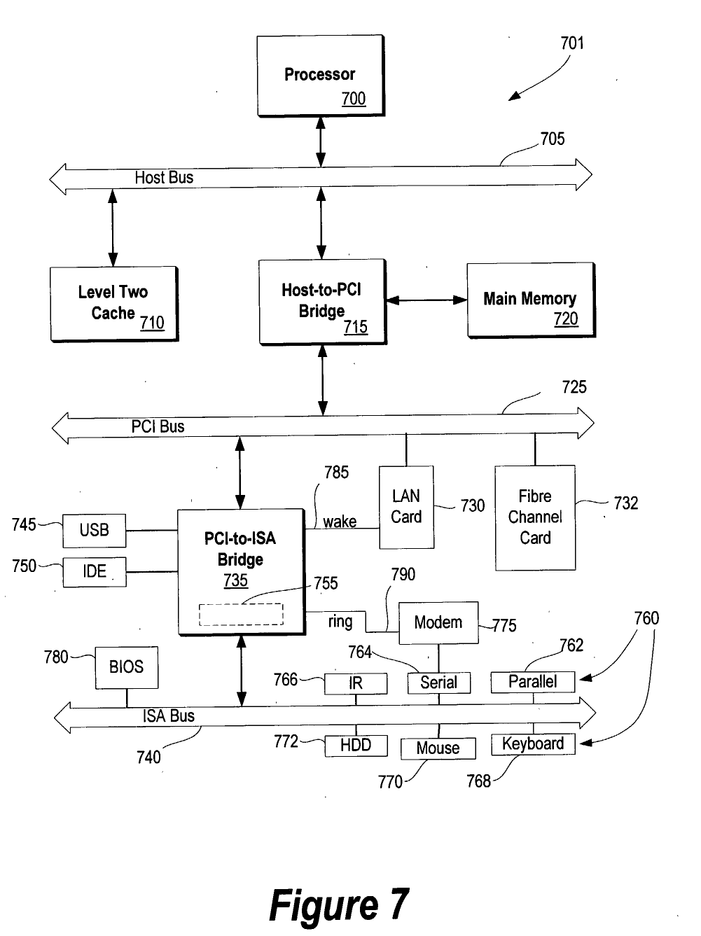

FIG. 7 illustrates information handling system 701 which is a simplified example of a computer system capable of performing the invention described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will, be explicitly recited in the claim, and in the absence of such recitation no such limitation is present. For a non-limiting example, as an aid to understanding the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for providing a user with an audio caption, said method comprising:
receiving a media stream from a first source;
receiving an enhanced captioning stream from a second source; and
displaying the enhanced captioning stream that corresponds to the media stream on an enhanced captioning device.

2. The method as described in claim 1 further comprising:
synchronizing the enhanced captioning stream with the media stream wherein the synchronization includes a media-playing device providing a synchronization signal.

3. The method as described in claim 2 wherein the synchronizing signal is selected from the group consisting of an audible signal, a wireless signal, and a manual signal.

4. The method as described in claim 2 wherein the synchronization signal includes an audible signal, the method further comprising:
detecting the audible signal;
comparing the audible signal with the enhanced captioning stream; and
performing the displaying based upon the comparing.

5. The method as described in claim 2 further comprising:
determining whether the media stream matches one or more words included in the enhanced captioning stream; and
changing an adjustment time in response to the determination.

6. The method as described in claim 5 further comprising:
storing the adjustment time in a non-volatile storage area; and
displaying the enhanced captioning stream using the adjustment time.

7. The method as described in claim 1 wherein the enhanced captioning device is selected from the group consisting of a personal digital assistant, a mobile telephone, and a computer.

8. The method as described in claim 1 further comprising:
downloading the enhanced captioning stream over a global computer network.

9. The method as described in claim 1 wherein the media stream is played using a media-playing device, wherein the media-playing device is selected from the group consisting of a radio, a television, a movie projector, a computer, a digital video disc player, and a video tape player.

10. The method as described in claim 1 wherein the media stream is audio from a live event.

11. The method as described in claim 1 wherein the enhanced captioning stream includes one or more captioning formats, wherein at least one of the captioning formats is selected from the group consisting of text and graphics.

12. An information handling system comprising:
one or more processors;
a memory accessible by the processors;
one or more nonvolatile storage devices accessible by the processors;
a display accessible by the processors; and
an audio captioning tool for processing audio captions, the audio captioning tool including:
receiving logic for receiving a media stream from a first source;
receiving logic for receiving an enhanced captioning stream from a second source; and
display logic for displaying the enhanced captioning stream that corresponds to the media stream on an enhanced captioning device.

13. The information handling system as described in claim 12 further comprising:
synchronization logic for synchronizing the enhanced captioning stream with the media stream wherein the synchronization includes a media-playing device providing a synchronization signal.

14. The information handling system as described in claim 13 wherein the synchronizing signal is selected from the group consisting of an audible signal, a wireless signal, and a manual signal.

15. The information handling system as described in claim 13 wherein the synchronization signal includes an audible signal, the method further comprising:
detection logic for detecting the audible signal;
comparison logic for comparing the audible signal with the enhanced captioning stream; and
execution logic for performing the displaying based upon the comparing.

16. The information handling system as described in claim 13 further comprising:
determination logic for determining whether the media stream matches one or more words included in the enhanced captioning stream; and
alteration logic for changing an adjustment time in response to the determination.

17. A computer program product stored in a computer operable media for providing audio captions, said computer program product comprising:
means for receiving a media stream from a first source;
means for receiving an enhanced captioning stream from a second source; and
means for displaying the enhanced captioning stream that corresponds to the media stream on an enhanced captioning device.

18. The computer program product as described in claim 17 further comprising:
means for synchronizing the enhanced captioning stream with the media stream wherein the synchronization includes a media-playing device providing a synchronization signal.

19. The computer program product as described in claim 18 wherein the synchronizing signal is selected from the group consisting of an audible signal, a wireless signal, and a manual signal.

20. The computer program product as described in claim 18 wherein the synchronization signal includes an audible signal, the computer program product further comprising:
means for detecting the audible signal;
means for comparing the audible signal with the enhanced captioning stream; and
means for performing the displaying based upon the comparing.

21. The computer program product as described in claim 18 further comprising:
means for determining whether the media stream matches one or more words included in the enhanced captioning stream; and
means for changing an adjustment time in response to the determination.

22. The computer program product as described in claim 21 further comprising:
means for storing the adjustment time in a non-volatile storage area; and
means for displaying the enhanced captioning stream using the adjustment time.

23. The computer program product as described in claim 17 wherein the enhanced captioning device is selected from the group consisting of a personal digital assistant, a mobile telephone, and a computer.

24. The computer program product as described in claim 17 further comprising:
means for downloading the enhanced captioning stream over a global computer network.

25. A method for providing a user with an audio caption, said method comprising:
receiving a media stream from a first source;
receiving an enhanced captioning stream from a second source;
synchronizing the enhanced captioning stream with the media stream based on the comparing;
displaying the enhanced captioning stream that corresponds to the media stream on an enhanced captioning device; and
displaying the enhanced captioning stream on an enhanced captioning device in response to the synchronization.

26. A method for providing a user with an audio caption, said method comprising:
receiving a media stream;
determining whether the media stream matches one or more words included in an enhanced captioning stream wherein the enhanced captioning stream is external to the media stream;
changing an adjustment time in response to the determination;
storing the adjustment time in a non-volatile storage area; and
displaying the enhanced captioning stream on an enhanced captioning device using the adjustment time.

27. An information handling system comprising:
one or more processors;
a memory accessible by the processors;
one or more nonvolatile storage devices accessible by the processors;
a display accessible by the processors; and
an audio captioning tool for processing audio captions, the audio captioning tool including:
receiving logic for receiving a media stream;
detection logic for detecting an audible signal, the audible signal corresponding to the media stream;
comparison logic for comparing the audible signal with an enhanced captioning stream wherein the enhanced captioning stream is external to the media stream;
synchronization logic for synchronizing the enhanced captioning stream with the media stream based on the comparing; and
display logic for displaying the enhanced captioning stream on an enhanced captioning device in response to the synchronization.

28. An information handling system comprising:
one or more processors;
a memory accessible by the processors;
one or more nonvolatile storage devices accessible by the processors;
a display accessible by the processors; and
an audio captioning tool for processing audio captions, the audio captioning tool including:
receiving logic for receiving a media stream;
determination logic for determining whether the media stream matches one or more words included in an enhanced captioning stream wherein the enhanced captioning stream is external to the media stream;
alteration logic for changing an adjustment time in response to the determination;
storage logic for storing the adjustment time in a non-volatile storage area; and
display logic for displaying the enhanced captioning stream on an enhanced captioning device using the adjustment time.

29. A computer program product stored in a computer operable media for providing audio captions, said computer program product comprising:
means for receiving a media stream from a first source;
means for receiving an enhanced captioning stream from a second source; and
means for detecting an audible signal, the audible signal corresponding to the media stream;
means for comparing the audible signal with an enhanced captioning stream wherein the enhanced captioning stream is external to the media stream;
means for synchronizing the enhanced captioning stream with the media stream based on the comparing; and
means for displaying the enhanced captioning stream on an enhanced captioning device in response to the synchronization.

30. A computer program product stored in a computer operable media for providing audio captions, said computer program product comprising:
means for receiving a media stream from a first source;
means for determining whether the media stream matches one or more words included in an enhanced captioning stream wherein the enhanced captioning stream is from a second source;
means for changing an adjustment time in response to the determination;
means for storing the adjustment time in a non-volatile storage area; and
means for displaying the enhanced captioning stream on an enhanced captioning device using the adjustment time.
